(19) United States
(12) Patent Application Publication
(10) Pub. No.: US 2019/0063222 A1
(43) Pub. Date: Feb. 28, 2019

(54) GAS TURBINE HAVING AXIAL THRUST PISTON AND RADIAL BEARING

(71) Applicant: SIEMENS AKTIENGESELLSCHAFT, München (DE)

(72) Inventors: Marco Larson, Mülheim (DE); Nicolas Savilius, Essen (DE)

(73) Assignee: Siemens Aktiengesellschaft, Munich (DE)

(21) Appl. No.: 16/072,540

(22) PCT Filed: Jan. 12, 2017
(86) PCT No.: PCT/EP2017/050552

§ 371 Date: Jul. 25, 2018

(30) Foreign Application Priority Data
Feb. 4, 2016 (DE) 10 2016 201 682.2

(51) Int. Cl. F01D 3/04; F01D 5/02; F01D 7/00

(52) U.S. Cl. CPC F01D 3/04; F01D 5/02; F05D 2240/52; F05D 2220/3215; F05D 2240/242; F01D 7/00

(57) ABSTRACT

A gas turbine having an axially adjustable rotor, has the following components: at least one external compressor air bleed for bleeding compressor air; a control valve for adjusting the amount of compressor air bled via the at least one external compressor air bleed; an axial thrust piston that can be supplied with the compressor bleed air via a supply line in such a way that a different axial compensation thrust is applied to same when the amount of compressor bleed air is adjusted; and a radial bearing which cooperates with the axial thrust piston for bearing purposes, and which can also be directly or indirectly supplied with the compressor bleed air via the supply line.

### CROSS REFERENCE TO RELATED APPLICATIONS

This application is the US National Stage of International Application No. PCT/EP2017/050552 filed Jan. 12, 2017, and claims the benefit thereof. The International Application claims the benefit of German Application No. DE 102016201682.2 filed Feb. 4, 2016. All of the applications are incorporated by reference herein in their entirety.

### FIELD OF INVENTION

The present invention relates to a gas turbine having a rotor which is adjustable with regard to an axial compensating thrust (axial compensating force).

### BACKGROUND OF INVENTION

A gas turbine, especially a single-shaft gas turbine, which typically has a compressor, a combustion chamber and an expansion turbine, demonstrates that during operation the axial forces which act upon the rotor are different, depending on operating mode. In this respect the gas turbine has thrust bearings which are designed for the purpose of being able to absorb the axial thrust (axial force) which occur during the different operating modes, i.e. being able to apply a counterforce to the rotor. During this, the axial thrust results from the thrust difference between the thrust in the compressor and the thrust in the expansion turbine. During full load operation, the axial thrust typically acts in the direction from the compressor to the turbine or in other words in the flow direction of the working medium in the gas turbine. If now the gas turbine is operated for example with lower outputs the axial thrust reduces, as a result of which for example the thrust bearing is unloaded. In the case of low partial load operating modes of the gas turbine, the thrust difference can even touch on close to zero so that in the case of very low partial load operating modes even a thrust reversal occurs. Such a thrust reversal is assisted, moreover, by manufacturing tolerances in the gas turbine which can ensure different axial thrusts in different gas turbines. The operating of external auxiliary systems, such as the anti-icing system, can also give rise to the occurrence of an axial thrust reversal. During an axial thrust reversal, the rotor is made to experience undesirable axial and also radial vibrations, as result of which not only the bearings but the entire gas turbine can be damaged.

In this respect, it is necessary to avoid such reversals of the axial thrust and to maintain good control over the axial thrust and its direction. To this end, gas turbines sometimes have an axial thrust piston upon which acts compressor air and on account of the force direction predetermined by the compressor air can act upon the rotor with an axial compensating force. Such an axial thrust compensation system is described for example in EP 2 011 963 A1 in which by means of an additional thrust device it is to be ensured that the thrust upon the thrust bearing is always positively directed, i.e. in the direction from the compressor to the expansion turbine. To this end, compressor air is extracted from the center section of the gas turbine and conducted into an inner annulus so that an additional force, which is exerted by the compressor air, acts upon the rotor. For variation of this additional thrust, the quantity of compressor air which flows into the annulus can be adjusted. The adjustment is carried out in this case as a function of the gas turbine load.

It is disadvantageous to this axial compensating thrust system which is known from the prior art, however, that the gas turbine has to be subjected to a structural modification in its center section. Moreover, the prevailing temperatures in the center section of the gas turbine are comparatively high so that comparatively high demands are to be made on the piping system for the conducting of the compressor air. Furthermore, it is shown to be disadvantageous that the compressor air of the expansion turbine which is extracted for the axial compensating thrust system is fed in close to its inlet, as a result of which a reduction of the gas turbine power output is the consequence. By the same token, such axial compensating thrust systems which are known from the prior art can be only comparatively poorly maintained since the maintenance operations in the center section of the gas turbine are costly as is generally known.

### SUMMARY OF INVENTION

In this respect, it is a technical requirement to propose a further gas turbine which can provide improved axial thrust compensating. The proposed gas turbine is especially to be more efficient with regard to power outputs, as well as to be more maintenance friendly.

The disadvantages which are known from the prior art are avoided by means of a gas turbine according to the claims.

The disadvantages which are known from the prior art are especially avoided by means of a gas turbine with an axially adjustable rotor, comprising the following components:—at least one external compressor bleed for extracting compressor air;—a control valve for adjusting the quantity of compressor air which is extracted via the at least one external compressor bleed;—an axial thrust piston which can be supplied with the extracted compressor air via a feed pipe in such a way that with adjustment of the quantity of compressor air a different axial compensating thrust is applied to this;—a radial bearing at the end of the gas turbine which especially interacts with the axial thrust piston in a bearing-technological manner, and which can also be supplied directly or indirectly with the extracted compressor air via the feed pipe.

At this point, reference is to be made to the fact that the radial bearing is typically supplied with the compressor air for sealing purposes and/or for cooling purposes.

The control valve can typically be designed as a flap valve.

According to the invention, it is therefore intended to allow the axial thrust piston, which is provided for acting upon the rotor with an axial compensating force, to interact with the radial bearing in a bearing-technological manner to the extent that both can be supplied directly or indirectly with the extracted compressor air via the feed pipe. In this respect, the compressor air which is extracted for the axial thrust piston can also be used for supplying the radial bearing. In this respect, no additional external compressor bleed, which would not be able to also supply the radial bearing, needs to be provided for the axial thrust piston.

Radial bearings are typically attached at the end in the gas turbine so that the axial thrust piston is also arranged in the end region of the gas turbine. If a maintenance event should now occur, the gas turbine can be conveniently maintained from the end region without for example the entire casing of the gas turbine having to be removed. It would be sufficient, for example, to just remove the radial bearing in order to gain direct access to the axial thrust piston.

Furthermore, it is important to make reference to the fact that the system according to the invention is arranged in a relatively cold region of the gas turbine. The compressor-air piping system can therefore be designed for comparatively low temperatures, as a result of which more favorable components can also be used. On account of the local proximity of axial thrust piston and radial bearing and also their interaction in a bearing-technological manner, two functions can be fulfilled by means of the compressor air which is extracted from the external compressor bleed. Firstly, the compressor air can provide the necessary axial thrust compensation by the compressor air flowing onto the axial thrust piston and acting upon this with the corresponding compensating force. Moreover, the compressor air can also serve as sealing air or cooling air in order to avoid for example the escape of oil from the radial bearing. This double function of the compressor air can therefore provide an efficiently operable gas turbine as well as a gas turbine which is easy to maintain.

According to a first embodiment of the invention, it is provided that the axial thrust piston and the radial bearing are interconnected in series with regard to the supply with compressor air. In other words, the one component receives the compressor air after it has been fed initially to the other component. The compressor air is typically fed in this case first to the axial thrust piston and transfers from this to the radial bearing on which for example it provides sealing against escape of bearing fluid or cools the radial bearing against heating. Both components, i.e. axial thrust piston and radial bearing, can be at least partially fluidically decoupled from each other by means of suitable seals. A complete decoupling with regard to the transfer of compressor air is not provided according to the first embodiment, however.

According to a second alternative embodiment of the invention, however, such a complete decoupling with regard to the transfer of compressor air from the one component to the other can be carried out since according to the alternative embodiment the axial piston and the radial bearing are interconnected in parallel with regard to the supply with compressor air. Consequently, both components are supplied with different compressor air flows, wherein a complete decoupling of both components is not absolutely necessary, however.

The components can therefore each be supplied with individually conditioned compressor air. In this way, for example the compressor air which is fed to the radial bearing can be specifically thermally conditioned, for example cooled. Also, for example the compressor air which is fed to the axial thrust piston can have a significantly greater flow rate in order for example to be able to apply the necessary axial compensating thrust. In each case, the two feed pipes, which supply the axial thrust piston and the radial bearing, are sealed fluidtight in relation to each other, at least in regions, so that feed can be carried out without fluidic interaction. In this case, however, the compressor air can be extracted from the same external bleed of the compressor. If the compressor air is conducted to the subject components, a transfer of the compressor air from the one component to the other can subsequently be carried out completely. According to the embodiment, each component can therefore be exposed to the action of a predetermined quantity of compressor air in a specific manner in order to therefore fulfill the desired function providing this is not impaired by the transfer.

According to a further embodiment of the invention, it is provided that provision is made for at least two external compressor bleeds for extracting compressor air at a different pressure level and both open into the feed pipe for the axial thrust piston and for the radial bearing. In this case, a mixing of compressor air at a different pressure level has already taken place before or even during the feed, wherein a new effective pressure level results. The mixing of both compressor air flows is typically carried out with an ejector which can enable a mixing of two compressor air flows at a different pressure level. According to the embodiment, compressor air can therefore be extracted at different regions of the compressor. An extraction of compressor air in the forward region of the compressor (with regard to the direction of the working fluid) allows in this case an extraction of compressor air at a comparatively low pressure level, wherein, however, this can be considered to be relatively favorable on account of the low compression of the compressor air. The compressor air which is extracted in the compressor further rearward (again with regard to the direction of the working fluid) is, however, in comparison comparatively expensive since a relatively intensive processing in respect to pressure engineering has already been carried out.

According to a further embodiment of the invention, it is provided that a cooling device, which enables cooling of the compressor air, is connected into the feed pipe. The heat from the compressor air which is dissipated with the aid of the cooling device can in turn be used for other purposes in the course of operation of the gas turbine as well as for other purposes which are no longer associated therewith. The cooling device allows thermal conditioning of the extracted compressor air at a temperature level which is suitable for use on the radial bearing since during feed of compressor air to the radial bearing a minimum temperature should not be exceeded.

It can furthermore be provided that an additional adjusting element is connected into the feed pipe, which additional adjusting element enables the compressor air which is extracted from the at least two external compressor bleeds and already intermixed to be adjusted with regard to its quantity. The adjusting element, in the case of at least two external compressor bleeds, therefore enables a further, possibly more accurate adjustment of the quantity of compressor air which is fed to the axial thrust piston and to the radial bearing.

According to a further embodiment of the invention, it is provided that a pressure measuring device, which allows a determination of the pressure level at which the compressor air is fed to the axial thrust piston, is connected into the feed pipe. The feed pipe extends in this case typically from a plenum, or from a plurality of plena, of the compressor up to the axial thrust piston or up to the radial bearing. The feed pipe can be formed by pipes which are attached externally on the casing of the gas turbine and by internal pipes which partially already exist. The pressure measuring device allows determination of the pressure level at which the compressor air is fed to the axial thrust piston. Since the pressure measurement in the feed pipe is directly related to the thrust force which is exerted via the axial thrust piston upon the rotor, a measured value which provides information about the current axial compensating thrust can therefore be produced. By means of this value, a desired and suitable axial compensating thrust during different operating conditions can in turn be established.

According to a further embodiment of the gas turbine according to the invention, it is provided that the axial thrust piston and the radial bearing are in contact with each other in the region of a bearing surface for providing the rotor bearing. Both components therefore interact with each other in a bearing-technological manner. As a result of the directly adjacent arrangement of both components, a thermal cooling action of the one component upon the other can therefore also be carried out. In particular, the axial thrust piston onto which flows a comparatively large amount of compressor air can contribute to the thermal conditioning of the radial bearing.

The invention is to be fully described in detail in the following text with reference to individual figures. In this case, reference is to be made to the fact that the figures are to be understood only schematically and no limitation at all with regard to the practicability results therefrom.

Reference is furthermore to be made to the fact that the technical features depicted in the figures, which are provided with the same designations, also have the same technical function.

Furthermore, reference is to be made to the fact that the subsequently described technical features are to be claimed in any combination with each other as well as in any combination with the previously described embodiments of the invention providing the combination resulting therefrom can achieve the object upon which the invention is based.

### BRIEF DESCRIPTION OF THE DRAWINGS

In this case, in the drawing:

FIG. 1 shows a schematic side sectional view through a first embodiment of a gas turbine according to the invention;

FIG. 2 shows a schematic sectional view through a further embodiment of a gas turbine according to the invention.

### DETAILED DESCRIPTION OF INVENTION

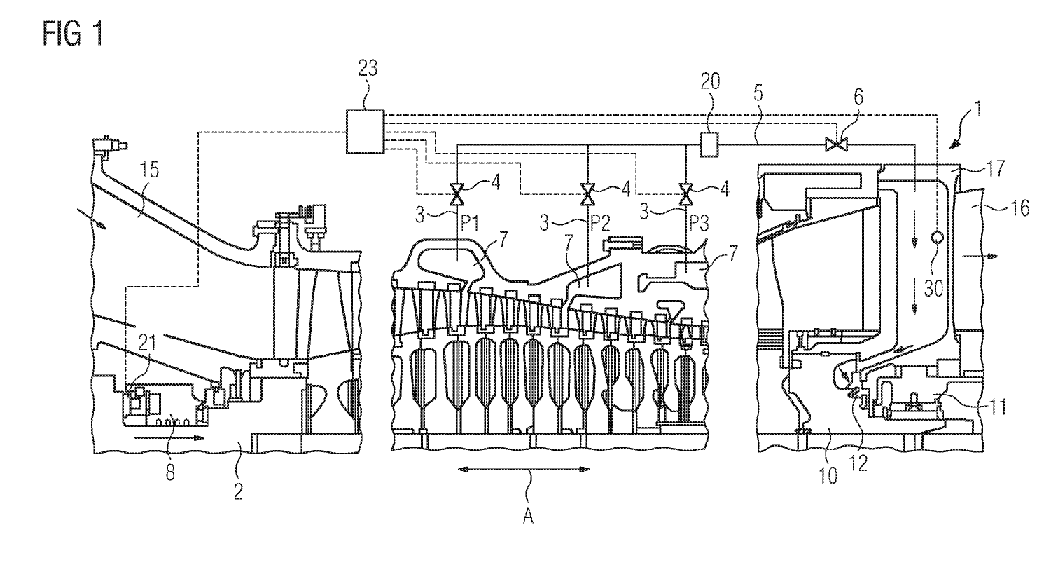

FIG. 1 shows a side sectional view through a first embodiment of the gas turbine 1 according to the invention which has a rotor 2 which is adjustable in the axial direction A with regard to an axial compensating thrust. During operation of the gas turbine 1, air is inducted via the intake duct 15, and is subsequently compressed in individual stages of the compressor.

After corresponding combustion with a fuel and downstream expansion in an expansion turbine, the working medium is discharged again from the gas turbine 1 via an exhaust gas diffuser 16 which is arranged in the region of the rear bearing support 17. The rotor 2 is equipped at the front end with a thrust bearing 8 which is designed for the purpose of absorbing the axial thrust forces, or to apply corresponding counterforces upon the rotor 2. At the rear end, the gas turbine has a radial bearing 11 which is sealed against an axial thrust piston 10 by means of seals 12. Both components, the radial bearing 11 and the axial thrust piston 10, interact in a bearing-technological manner by for example the axial thrust piston 10 being arranged on a bearing surface of the radial bearing 11 for bearing purposes.

If the gas turbine 1 is now operated in different operating states, a change of the axial thrust upon the rotor 2 in the axial direction A occurs. In this case, different forces are to be absorbed by the thrust bearing 8 or at relatively low partial load operating modes an axial thrust reversal may also occur. In such a case, the direction of the resulting axial thrust changes from initially the compressor to the expansion turbine to a direction which is oriented exactly opposite this. As a result of such an axial thrust reversal, undesirable vibrations of the rotor 2 can occur, as a result of which not only the thrust bearing 8 is negatively affected but the entire gas turbine 1 can be damaged.

In order to now expose the rotor 2 to the action of a suitable compensating force the present embodiment of the gas turbine 1 has three external compressor bleeds 3 via which compressor air can be extracted from individual plena of the compressor at different pressure levels P1, P2 and P3. The compressor air flows can be introduced into a feed pipe 5 and mixed. For suitable mixing of the individual flows suitable ejectors can be used for example (not shown in the present case). In order to be able to adjust the quantity of compressor air from the individual plena 7 during extraction the present invention has in each case a control valve 4 which is associated with the external bleeds 3 in each case. By means of these, the values of the extracted compressor air flows from the individual plena can be adjusted in a specific manner. The mixed flow of compressor air can also thermally interact with a cooling device 20 before feed to the axial thrust piston 10 and to the radial bearing 11, as a result of which the just mentioned components can be thermally conditioned. This is particularly advantageous if the extracted compressor air has a comparatively high temperature level, and therefore would be unsuitable to be in direct contact with the radial bearing 11.

In order to suitably adjust the overall flow of compressor air in the feed pipe 5, an adjusting element 6 is connected into the feed pipe 5 and allows the quantity of compressor air which is fed to the radial bearing 11 and to the axial thrust piston 10 to be again additionally adjusted.

The adjusting element 6 and the control valves 4 are suitably adjusted according to the embodiment by means of an adjusting unit 23 which in its turn can again take into account suitable measured values. The measured values can be delivered for example via a measuring device 21 in the region of the thrust bearing 8, which measured values are received for example as pressure or force (=thrust). In particular, for example the axial thrust on the thrust bearing can therefore be directly tracked. Also, the adjusting unit 23 can take into consideration the measured values of a pressure measuring device 30 which is attached in the region of the bearing support 17 of the gas turbine 1. The pressure measuring device 30 senses in this case the pressure which prevails in the compressor air duct and which is correlated directly with the pressure upon the axial thrust piston 10. The compressor air duct in the bearing support 17 is in this case part of the feed pipe 5. If the compressor air is directed onto the axial thrust piston 10, this transmits a compensating force (compensating thrust) to the rotor 2. The compressor air then flows via the seal 12 to the radial bearing 11 and seals this and additionally cools this, or is discharged from there for example into the environment.

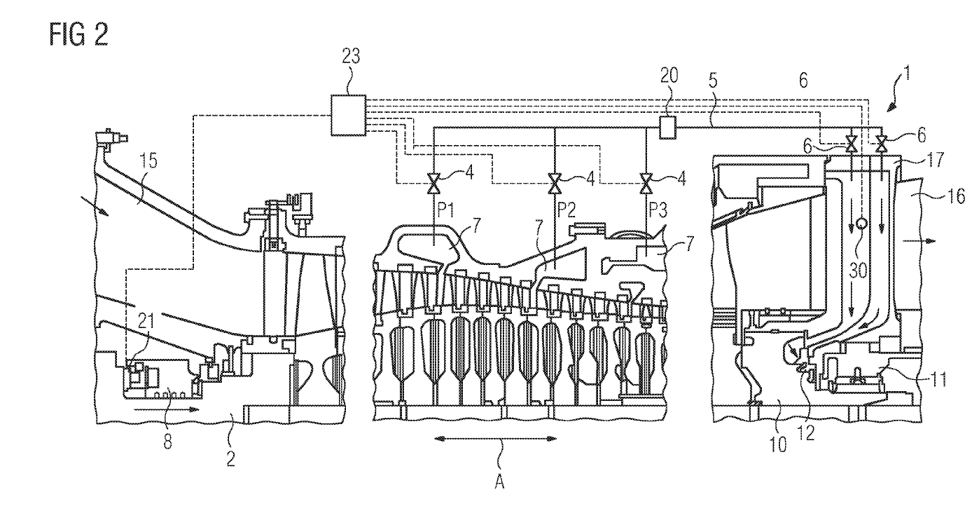

FIG. 2 shows a further embodiment of the gas turbine 1 according to the invention, which differs from the embodiment depicted in FIG. 1 only to the effect that in the bearing support 17 there are now two separate fluid passages which are designed for the purpose of conducting the compressor air, which is introduced into the respective passages, to one of the components comprising axial thrust piston 10 and radial bearing 11 respectively. Both feed pipes are provided individually with an adjusting element 6 so that the two passages can be supplied in each case with different quantities of compressed air. After the compressed air has been transferred to the components, this can either not be mixed with full decoupling or can be intermixed again with partial decoupling. Therefore, it is possible for example that the compressor air which is fed to the axial thrust piston 10 is fed at least partially to the radial bearing. In this case, for example the compressor air would flow via the seal 12 to the radial bearing 11. It is also conceivable to design the seal 12 so that there is a largely fluid decoupling of both components, or so that the compressor air from the respective components makes its way into different discharge passages for discharging from the gas turbine.

Further embodiments are gathered from the dependent claims.

1. A gas turbine having an axially adjustable rotor, comprising the following components:
at least one external compressor bleed for extracting compressor air;
a control valve for adjusting the quantity of compressor air which is extracted via the at least one external compressor bleed;
an axial thrust piston which can be supplied with the extracted compressor air via a feed pipe in such a way that with adjustment of the quantity of compressor air a different axial compensating thrust is applied to this;
a radial bearing at the end of the gas turbine which interacts with the axial thrust piston in a bearing-technological manner, and which can also be supplied directly or indirectly with the extracted compressor air via the feed pipe.

2. The gas turbine as claimed in claim 1,
wherein the axial thrust piston and the radial bearing are interconnected in series with regard to the supply with compressor air.

3. The gas turbine as claimed in claim 1,
wherein the axial thrust piston and the radial bearing are interconnected in parallel with regard to the supply with compressor air.

4. The gas turbine as claimed in claim 1,
wherein provision is made for at least two external compressor bleeds for extracting compressor air at a different pressure level and both open into the feed pipe for the axial thrust piston and for the radial bearing.

5. The gas turbine as claimed in claim 1, further comprising:
a cooling device, which enables cooling of the compressor air, which is connected into the feed pipe.

6. The gas turbine as claimed in claim 4, further comprising:
an additional adjusting element that is connected into the feed pipe, which additional adjusting element enables the compressor air which is extracted from the at least two external compressor bleeds and is already intermixed to be adjusted with regard to its quantity.

7. The gas turbine as claimed in claim 1, further comprising:
a pressure measuring device, which allows determination of the pressure level at which the compressor air is fed to the axial thrust piston, which is connected into the feed pipe.

8. The gas turbine as claimed in claim 1,
wherein the axial piston and the radial bearing are in contact with each other in a bearing-technological manner in the region of a bearing surface for providing the rotor bearing.
